(19) United States
(12) Patent Application Publication
(10) Pub. No.: US 2011/0104405 A1
(43) Pub. Date: May 5, 2011

(54) Inkjet receiving agent for oil-based pigment ink, inkjet recording medium for oil based pigment ink, and printed material

(75) Inventors: Yukie Saitou, Osaka (JP); Jun Shirakami, Osaka (JP); Kazunori Tanaka, Osaka (JP)

(73) Assignee: DIC Corporation, Tokyo (JP)

(21) Appl. No.: 12/735,124

(22) PCT Filed: May 19, 2009
(86) PCT No.: PCT/JP2009/059155

§ 371 Date: Jun. 17, 2010

(30) Foreign Application Priority Data
Jul. 1, 2008 (JP) 2008-172240

(51) Int. Cl. B32B 3/10; C08L 33/24; C08L 33/12; B41M 5/00

(52) U.S. Cl. 428/32.1; 524/555; 524/560; 428/195.1

(57) ABSTRACT

There are provided in the present invention: an inkjet receiving agent for an oil based pigment ink and an inkjet recording medium for an oil based pigment ink that includes an inkjet receiving layer formed using the inkjet receiving agent, the inkjet receiving agent including a vinyl polymer (A) dispersed in a water-based medium (B), the vinyl polymer (A) having a glass transition temperature of 10 to 70° C. and being obtained by polymerizing a vinyl monomer mixture containing 30 to 70% by mass of methyl methacrylate (a1) and a total of 0.2 to 5.0% by mass of at least one monomer selected from the group consisting of a carboxyl group containing vinyl monomer (a2) and an amide group containing vinyl monomer (a3), wherein an elution rate is 10 to 90% by mass when the vinyl polymer (A) is immersed in tetrahydrofuran of 25° C. for 24 hours.

### TECHNICAL FIELD

The present invention relates to an inkjet receiving agent for an oil based pigment ink, an inkjet recording medium for an oil based pigment ink which includes an ink receiving layer formed by using the inkjet receiving agent, and a printed material which is printed by an oil based pigment ink.

### BACKGROUND ART

In recent years, in the rapidly growing industry associated with the inkjet printing, dramatic progress has been made for enhancing the performance of inkjet printers and improving the ink quality, and it is becoming possible to easily obtain clear, high definition images equivalent to silver halide photographs even in the home. For this reason, the current use of inkjet printers is not restricted to that in household and their use for producing huge advertising billboards or the like has now been discussed.

In addition, enhancements in the definition and quality of images of inkjet printed material can be attributed largely to the improvements in the printing ink as well as the enhancement of printer performance described above. More specifically, the use of pigment ink which is known to have a high level of color developing properties equivalent to those of dye ink and also to be capable of forming printed images exhibiting excellent durability as compared to the conventional dye ink has become popular in recent years.

As the pigment inks described above, water based pigment inks and solvent based pigment inks are generally known. The water based pigment inks are those in which a pigment is dispersed in an aqueous medium, and printed images or the like which are unlikely to lose colors or to develop cracks during printing can be formed using such inks.

However, since the water based pigment inks are themselves hydrophilic, for example, when rainwater or the like is attached, it caused the bleeding and color loss of printed images or the crack development on the printed image surface at times.

On the other hand, the solvent based pigment inks are those in which particles of a pigment ink are dispersed in an organic solvent, and are also known as oil based pigment inks. Since such solvent based pigment inks contain ink particles which are themselves relatively hydrophobic, they can be suitably used for forming printed images exhibiting a water resistance level at which the bleeding of printed images or the like attributable to the attachment of rainwater or the like is not caused, and are thus attracting attention in recent years.

However, the printed images that are capable of preventing the color loss, bleeding, and crack development and are also excellent in terms of water resistance cannot be readily obtained by simply using the aforementioned solvent based pigment inks, but rather, it is necessary to use an inkjet recording medium having an ink receiving layer that is compatible with the solvent based pigment inks.

More specifically, many of the conventional inkjet recording media have an ink receiving layer developed for aqueous dye inks, and are designed in order to improve the absorption properties of the aqueous medium in the ink and to improve the dye fixation. For this reason, it has been a common knowledge in the relevant technical field that even when a printing is conducted on the aforementioned inkjet recording medium using the aforementioned solvent based pigment ink, the inkjet receiving layer cannot absorb an organic solvent efficiently, as a result of which an image that shows a high level of color development and is capable of preventing the bleeding and color loss cannot be obtained.

Accordingly, in recent years, studies have been made on the receiving layer which is compatible with a solvent based pigment ink. For example, a receiving agent is known which forms an ink receiving layer constituted of 50 to 100% by weight of methyl methacrylate and 0 to 50% by weight of (meth)acrylic or vinyl-based monomers other than methyl methacrylate and containing an acrylic resin having a weight average molecular weight of at least 300,000 up to 1,000,000 as a main component thereof (for example, refer to Patent Document 1).

However, with the ink receiving layers as those described in the aforementioned document, for example, when an inkjet printing is conducted on a relatively large medium such as an outdoor advertisement, since the organic solvent contained in the ink cannot be absorbed adequately, it often caused considerable deterioration in the ink drying properties, bleeding of the printed images and the occurrence of cracks or the like.

In addition, since the ink receiving layer described in the aforementioned Patent Document 1 is one formed using an inkjet receiving agent in which the aforementioned specific acrylic resin is dissolved in an organic solvent, an additional step for volatilizing a large amount of organic solvent is often required when producing an inkjet recording medium.

As described above, the current situation was such that an aqueous inkjet receiving agent has not been developed so far which is capable of forming a receiving layer even when a printing is conducted using an oil based pigment ink, the receiving layer capable of forming printed images which are unlikely to cause bleeding, crack development, color loss or the like, and are excellent in terms of drying properties, water resistance and color optical density.

### PRIOR-ART DOCUMENT(S)

### Patent Document(s)

Patent Document 1: Japanese Unexamined Patent Application, First Publication No. 2004-291561

SUMMARY OF INVENTION

### Problems to be Solved by the Invention

An object of the present invention is to provide an aqueous inkjet receiving agent for an oil based pigment ink and an inkjet recording medium for an oil based pigment ink which includes an ink receiving layer formed by using the inkjet receiving agent, the inkjet receiving agent capable of forming an ink receiving layer which provides an excellent level of printing properties sufficient for preventing the bleeding, crack development, color loss or the like of the printed images, provides an oil based pigment ink with an excellent level of drying properties, and which also enables the formation of highly clear printed images provided with an excellent level of water resistance.

### Means for Solving the Problems

The present inventors and others initially thought that the occurrence of bleeding and color loss of the printed images or the like can be suppressed to a certain extent if the drying properties of the oil based pigment ink can be improved. Accordingly, studies have been conducted by using, as a resin for forming an inkjet receiving layer, an inkjet receiving agent containing a vinyl polymer capable of absorbing a relatively large amount of solvents in the ink.

More specifically, various combinations of vinyl monomers used in the production of the aforementioned vinyl polymers have been studied, and, for example, an inkjet receiving agent has been studied which contains a vinyl polymer obtained by polymerizing a vinyl monomer mixture containing a combination of methyl methacrylate, a carboxyl group containing vinyl monomer, an amide group containing vinyl monomer and the like.

As a result, when an inkjet receiving agent is used which includes a vinyl polymer obtained by polymerizing a vinyl monomer mixture containing 30 to 70% by mass of methyl methacrylate (a1) and a total of 0.2 to 5.0% by mass of at least one monomer selected from the group consisting of a carboxyl group containing vinyl monomer (a2) and an amide group containing vinyl monomer (a3), the drying properties of ink and the water resistance of printed images have improved to some extent. However, the level of improvements was still unsatisfactory.

The present inventors and others have conducted further studies using the inkjet receiving agent obtained above and discovered that, among various vinyl polymers obtained by polymerizing a vinyl monomer mixture containing 30 to 70% by mass of methyl methacrylate (a1) and a total of 0.2 to 5.0% by mass of at least one monomer selected from the group consisting of a carboxyl group containing vinyl monomer (a2) and an amide group containing vinyl monomer (a3), if the inkjet receiving agent contains a vinyl polymer (A) in which a glass transition temperature is 10 to 70° C. and an elution rate is 10 to 90% by mass when immersed in tetrahydrofuran of 25° C. for 24 hours, a receiving layer can be formed which hardly causes a bleeding of printed images or the crack development thereon, provides an oil based pigment ink with an excellent level of drying properties, and is capable of forming highly clear printed images provided with an excellent level of water resistance suitable for the outdoor use.

In other words, the present invention relates to an inkjet receiving agent for an oil based pigment ink and an inkjet recording medium for an oil based pigment ink which includes an ink receiving layer obtained by using the inkjet receiving agent, the inkjet receiving agent for an oil based pigment ink that is characterized by including a vinyl polymer (A) dispersed in a water-based medium (B), the vinyl polymer (A) having a glass transition temperature of 10 to 70° C. and being obtained by polymerizing a vinyl monomer mixture containing 30 to 70% by mass of methyl methacrylate (a1) and a total of 0.2 to 5.0% by mass of at least one monomer selected from the group consisting of a carboxyl group containing vinyl monomer (a2) and an amide group containing vinyl monomer (a3), wherein the elution rate is 10 to 90% by mass when the vinyl polymer (A) is immersed in tetrahydrofuran of 25° C. for 24 hours.

### EFFECTS OF THE INVENTION

According to the inkjet receiving agent for an oil based pigment ink of the present invention, an ink receiving layer can be formed which provides an excellent level of printing properties sufficient for preventing the bleeding, crack development or the like of printed images, provides an oil based pigment ink with an excellent level of drying properties, and which also enables the formation of highly clear printed images provided with an excellent level of water resistance suitable for the outdoor use. Therefore, the inkjet receiving agent for an oil based pigment ink according to the present invention can be applied to an inkjet recording medium used in the production of advertisements, billboards, signposts and the like which can be installed either indoors or outdoors.

### EMBODIMENTS FOR CARRYING OUT THE INVENTION

The present invention relates to an inkjet receiving agent for an oil based pigment ink characterized by being prepared by dispersing, in a water-based medium (B), a vinyl polymer (A) having a glass transition temperature of 10 to 70° C. obtained by polymerizing a vinyl monomer mixture containing 30 to 70% by mass of methyl methacrylate (a1) and a total of 0.2 to 5.0% by mass of at least one monomer selected from the group consisting of a carboxyl group containing vinyl monomer (a2) and an amide group containing vinyl monomer (a3), wherein the elution rate is 10 to 90% by mass when the vinyl polymer (A) is immersed in tetrahydrofuran of 25° C. for 24 hours.

As a vinyl polymer (A) used in the present invention, it is essential to use those provided with the following specific requirements for achieving the effects of the present invention.

Firstly, as the vinyl polymer (A), it is important to use a vinyl polymer having an elution rate with respect to tetrahydrofuran (THF) within a range from 10 to 90% by mass.

Here, the elution rate indicates the mass ratio of the vinyl polymer (A) eluted into tetrahydrofuran from a film that is formed using the vinyl polymer (A) when the film is immersed in tetrahydrofuran of 25° C. for 24 hours.

More specifically, the elution rate is determined in the following manner. A film having a dimension of 3 cm×3 cm and a thickness of 150 μm is prepared using the vinyl polymer (A), and the mass (X) thereof is then measured. Subsequently, the film is immersed in the tetrahydrofuran which is adjusted to a temperature of 25° C. for 24 hours, and the film residues that did not dissolve in tetrahydrofuran are then separated by filtration using a metal gauze having 300 meshes. The residues are dried at 108° C. for 1 hour, and the mass (Y) thereof is then measured. Then, a value is derived which corresponds to the elution rate used in the present invention, based on the formula: [{(X)−(Y)}/(X)]×100, using the aforementioned values for mass (X) and mass (Y).

Tetrahydrofuran is a solvent which readily dissolves resins, as compared to other organic solvents. For this reason, the vinyl polymers having an elution rate of less than 10% by mass with respect to tetrahydrofuran exhibits a low absorption capacity for organic solvents contained in common oil based pigment inks. As a result, it is difficult to form an ink receiving layer which prevents the bleeding of the oil based pigment ink or the like and exhibits excellent drying properties by the use of an inkjet receiving agent containing such vinyl polymers.

On the other hand, the vinyl polymers having the aforementioned elution rate of greater than 90% by mass exhibits a very high solubility for organic solvents contained in oil based pigment inks. As a result, it is difficult to form an ink receiving layer which is capable of adequately preventing the occurrence of bleeding or cracks in the printed images formed using the oil based pigment ink by the use of an inkjet receiving agent containing such vinyl polymers.

As the vinyl polymer (A), it is preferable to use those having the elution rate within a range from 20 to 50% by mass for achieving both the prevention of cracks, color loss or the like in the printed images and the provision of adequate drying properties for the oil based pigment ink.

The extent of the aforementioned elution rate varies depending on the combination, degree of crosslinking, molecular weight or the like of vinyl monomers used for producing the vinyl polymer (A).

The adjustments in terms of the structure, degree of crosslinking, molecular weight or the like of the vinyl polymer (A) can be carried out for those skilled in the art by appropriately adjusting the composition of monomers constituting the vinyl polymer (A) and the production method therefor, the types of polymerization initiators and chain transfer agents and the amount of those used, or the like.

More specifically, the vinyl polymer (A) having a desired level of elution rate can be obtained in the following manner: that is, when polymerizing a vinyl monomer mixture containing 30 to 70% by mass of methyl methacrylate (a1) and a total of 0.2 to 5.0% by mass of at least one monomer selected from the group consisting of a carboxyl group containing vinyl monomer (a2) and an amide group containing vinyl monomer (a3), the weight average molecular weight of the obtained vinyl polymer (A) is roughly adjusted to 1,000,000 or greater by the method in which a chain transfer agent is used in an amount of 0 to 0.15% by mass with respect to the total amount of the vinyl monomer mixture, the method in which 0 to 1.5% by mass of a vinyl monomer to be described later containing a cross-linkable functional group is used in combination with the vinyl monomer mixture, or the like.

Secondly, as the vinyl polymer (A), it is essential to use those having a glass transition temperature of 10 to 70° C. for preventing the development of cracks in the printed images.

The glass transition temperature of the vinyl polymer (A) is mainly determined depending on the composition of vinyl monomers used for producing the vinyl polymer (A). More specifically, the vinyl polymer (A) having the aforementioned predetermined glass transition temperature can be obtained by essentially using 30 to 70% by mass of methyl methacrylate (a1) and a total of 0.2 to 5.0% by mass of at least one monomer selected from the group consisting of a carboxyl group containing vinyl monomer (a2) and an amide group containing vinyl monomer (a3), and if necessary, a vinyl monomer to be described later which is capable of forming a homopolymer having a glass transition temperature of about −100° C. to about 55° C. is appropriately used in combination.

The glass transition temperature is preferably within a range from 15 to 35° C. from the viewpoint of achieving the prevention of bleeding and crack development in the printed images, and the provision of an adequate level of drying properties to the oil based pigment ink as well as a satisfactory level of film-forming properties to the inkjet receiving agent.

Thirdly, as the vinyl polymer (A), it is essential to use those having an elution rate and a glass transition temperature within the aforementioned predetermined ranges, and also those which are obtained by polymerizing a vinyl monomer mixture containing 30 to 70% by mass of methyl methacrylate (a1), a total of 0.2 to 5.0% by mass of at least one monomer selected from the group consisting of a carboxyl group containing vinyl monomer (a2) and an amide group containing vinyl monomer (a3), and if necessary, other vinyl monomers.

The methyl methacrylate (a1) is an essential component for improving the compatibility of the oil based pigment ink with the ink receiving layer and for providing the oil based pigment ink with adequate absorption and drying properties. Here, even when a predetermined amount of a monomer having a similar structure such as methyl acrylate or ethyl methacrylate is used instead of methyl methacrylate (a1), an inkjet receiving agent capable of forming an ink receiving layer that provides an oil based pigment ink with adequate absorption and drying properties cannot be obtained.

In addition, it is essential to use the aforementioned methyl methacrylate (a1) within a range from 30 to 70% by mass with respect to the total amount of the aforementioned vinyl monomer mixture, and the use thereof within a range from 40 to 65% by mass is particularly preferable.

Here, if the amount of the aforementioned methyl methacrylate (a1) used is greater than 70% by mass, it may cause a deterioration in the drying properties of the formed ink receiving layer and the occurrence of bleeding and cracks in the printed images.

In addition, the aforementioned vinyl monomer mixture contains a total of 0.2 to 5.0% by mass of at least one monomer selected from the group consisting of a carboxyl group containing vinyl monomer (a2) and an amide group containing vinyl monomer (a3). The aforementioned carboxyl group containing vinyl monomer (a2) and amide group containing vinyl monomer (a3) are used for introducing the aforementioned predetermined amount of carboxyl group and amide group into the vinyl polymer (A) to be obtained, and for enabling the formation of printed images provided with excellent levels of printing properties, water resistance and the like which may prevent the occurrence of bleeding or the like.

When the total amount of the aforementioned carboxyl group containing vinyl monomer (a2) and amide group containing vinyl monomer (a3) exceeds 5% by mass, the amount of carboxyl group and amide group introduced into the vinyl polymer (A) also increases, which may result in a deterioration in the water resistance of the ink receiving layer itself and the occurrence of cracks and bleeding in the formed printed images. On the other hand, when the total amount of the aforementioned carboxyl group containing vinyl monomer (a2) and amide group containing vinyl monomer (a3) is less than 0.2% by mass, this may also cause cracks and bleeding in the surface of the formed printed images.

As the carboxyl group containing vinyl monomer (a2), for example, acrylic acid, methacrylic acid, β-carboxyethyl(meth)acrylate, 2-(meth)acryloylpropionate, crotonic acid, itaconic acid, maleic acid, fumaric acid, itaconic acid half esters, maleic acid half esters, maleic anhydride, itaconic anhydride, and β-(meth)acryloyloxyethyl hydrogen succinate can be used, and among them, it is particularly preferable to use methacrylic acid.

As the amide group containing vinyl monomer (a3), for example, (meth)acrylamide, N-methylol (meth)acrylamide, N-isopropoxymethyl (meth)acrylamide, N-butoxymethyl (meth)acrylamide, N-isobutoxymethyl (meth)acrylamide, diacetone (meth)acrylamide, N-monoalkyl (meth)acrylamide, and N,N-dialkyl (meth)acrylamide can be used, and among them, it is particularly preferable to use acrylamide.

In the present invention, it is preferable to combine the aforementioned carboxyl group containing vinyl monomer (a2) and amide group containing vinyl monomer (a3) for use, and, for example, it is preferable to use methacrylic acid and acrylamide in combination since the occurrence of bleeding and cracks in the printed images to be formed can be prevented, and also an inkjet receiving agent capable of forming a receiving layer provided with an excellent level of ink drying properties can be obtained.

In addition, in those cases where the aforementioned carboxyl group containing vinyl monomer (a2) is used when producing the vinyl polymer (A), it is preferable that the carboxyl groups within the vinyl polymer (A) be neutralized using a neutralizing agent from the viewpoint of providing the vinyl polymer (A) with an adequate level of water dispersion stability.

Examples of the neutralizing agent include alkali metal compounds such as sodium hydroxide and potassium hydroxide; alkali earth metal compounds such as calcium hydroxide and calcium carbonate; ammonia; and water-soluble, organic amines such as monomethylamine, dimethylamine, trimethylamine, monoethylamine, diethylamine, triethylamine, monopropylamine, dimethylpropylamine, monoethanolamine, diethanolamine, triethanolamine, ethylenediamine, and diethylenetriamine, and one type thereof alone or a mixture of two or more types thereof can be used. In particular, when an improvement in the water resistance of a coating film to be obtained is desired, it is preferable to use ammonia which disperses at normal temperature or when heated.

Further, as the vinyl polymer (A), it is preferable to use a vinyl polymer having a weight average molecular weight of 1,000,000 or greater from the viewpoint of providing an oil based pigment ink with superior drying properties and obtaining a receiving layer capable of forming clear images which exhibit an excellent level of water resistance. Although the upper limit for the weight average molecular weight of the vinyl polymer (A) is not particularly limited, roughly speaking, it is preferably not greater than 10,000,000.

Further, as the vinyl monomer mixture used in the production of the vinyl polymer (A), in addition to those described earlier, other vinyl monomers can be used where necessary.

As the above-mentioned other vinyl monomers, esters of (meth)acrylic acid other than methyl methacrylate can be used, and, for example, (meth)acrylate esters such as methyl acrylate, ethyl(meth)acrylate, n-butyl(meth)acrylate, i-butyl(meth)acrylate, t-butyl(meth)acrylate, 2-ethylhexyl(meth)acrylate, hexyl(meth)acrylate, cyclohexyl(meth)acrylate, octyl(meth)acrylate, nonyl(meth)acrylate, dodecyl(meth)acrylate, stearyl(meth)acrylate, isobornyl(meth)acrylate, dicyclopentanyl(meth)acrylate, phenyl(meth)acrylate, and benzyl(meth)acrylate; 2,2,2-trifluoroethyl(meth)acrylate, 2,2,3,3-pentafluoropropyl(meth)acrylate, perfluorocyclohexyl(meth)acrylate, 2,2,3,3-tetrafluoropropyl(meth)acrylate, and β-(perfluorooctypethyl(meth)acrylate can be used.

In addition, as the above-mentioned other vinyl monomers, vinyl acetate, vinyl propionate, vinyl butyrate, vinyl versatate, methyl vinyl ether, ethyl vinyl ether, propyl vinyl ether, butyl vinyl ether, amyl vinyl ether, hexyl vinyl ether, (meth)acrylonitrile, styrene, α-methylstyrene, vinyl toluene, vinylanisole, α-halostyrene, vinyl naphthalene, divinylstyrene, isoprene, chloroprene, butadiene, ethylene, tetrafluoroethylene, vinylidene fluoride, N-vinylpyrrolidone, 2-hydroxyethyl(meth)acrylate, 2-hydroxypropyl(meth)acrylate, polyethylene glycol mono(meth)acrylate, glycerol mono(meth)acrylate, vinyl sulfonic acid, styrene sulfonic acid, allyl sulfonic acid, 2-methylallyl sulfonic acid, 2-sulfoethyl(meth)acrylate, 2-sulfopropyl(meth)acrylate, (meth)acrylamide-t-butyl sulfonic acid, and “ADEKA REASOAP PP-70” and “ADEKA REASOAP PPE-710” (manufactured by ADEKA Corporation), the salts thereof, or vinyl monomers having other hydrophilic groups, such as a hydroxyl group, a sulfonic group, a sulfate group, a phosphate group, and a phosphate ester group, can be used.

Among those mentioned above, it is preferable to use a vinyl monomer capable of forming the aforementioned homopolymer having a glass transition temperature from about −100° C. to about 55° C. in view of adjusting the glass transition temperature of the vinyl polymer (A) to be obtained within a range from 10 to 70° C. More specifically, it is preferable to use an alkyl (meth)acrylate ester having an alkyl group of 2 to 12 carbon atoms, more preferably an alkyl (meth)acrylate ester (a4) having an alkyl group of 3 to 8 carbon atoms, and in view of obtaining an inkjet receiving agent capable of forming a receiving layer excellent in terms of ink drying properties, it is particularly preferable to use butyl acrylate.

In the present invention, it is particularly preferable to use the alkyl(meth)acrylate ester (a4) having an alkyl group of 3 to 8 carbon atoms as the aforementioned other vinyl monomer in an amount within a range from 10 to 50% by mass with respect to the vinyl monomer mixture as a whole used in the production of the vinyl polymer (A), in view of adjusting the glass transition temperature of the vinyl polymer (A) within a range from 10 to 70° C., and obtaining an inkjet receiving agent which may prevent the development of cracks in the printed images.

In addition, as the aforementioned other vinyl monomers, a vinyl monomer containing a cross-linkable functional group can be used, if necessary, from the viewpoint of adjusting the crosslinking density of the vinyl polymer (A) and thereby adjusting the elution rate of the vinyl polymer (A) in tetrahydrofuran within a predetermined range.

The vinyl monomer containing a cross-linkable functional group refers to those having 2 or more polymerizable unsaturated double bonds, and, for example, polymerizable monomers containing a glycidyl group such as glycidyl (meth)acrylate, allyl glycidyl ether; polymerizable monomers containing an amino group such as aminoethyl (meth)acrylate, N-monoalkyl aminoalkyl (meth)acrylate, and N,N-dialkylaminoalkyl (meth)acrylate; polymerizable monomers containing a silyl group such as vinyltrichlorosilane, vinyltrimethoxysilane, vinyltriethoxysilane, vinyltris(β-methoxyethoxy)silane, γ-(meth)acryloxypropyltrimethoxysilane, γ-(meth)acryloxypropyltriethoxysilane, γ-(meth)acryloxypropylmethyldimethoxysilane, γ-(meth)acryloxypropylmethyldiethoxysilane, γ-(meth)acryloxypropyltriisopropoxysilane, N-β-(N-vinylbenzylaminoethyl)-γ-aminopropyltrimethoxysilane, and the hydrochloric acid salts thereof; polymerizable monomers containing an aziridinyl group such as 2-aziridinylethyl(meth)acrylate; polymerizable monomers containing an isocyanate group and/or a block isocyanate group such as (meth)acryloylisocyanate, phenol or methyl ethyl ketoxime addition products of ethyl(meth)acryloylisocyanate; polymerizable monomers containing an oxazoline group such as 2-isopropenyl-2-oxazoline and 2-vinyl-2-oxazoline; polymerizable monomers containing a cyclopentenyl group such as dicyclopentenyl(meth)acrylate; polymerizable monomers containing an allyl group such as allyl(meth)acrylate; vinyl monomers containing a carbonyl group such as acrolein; and vinyl monomers containing an acetoacetyl group such as acetoacetoxyethyl(meth)acrylate can be used.

In addition, as the vinyl monomer containing a cross-linkable functional group, functional ethylenic unsaturated monomers having 3 or more polymerizable unsaturated double bonds can also be used, and, for example, ethylene glycol di(meth)acrylate, 1,6-hexanediol di(meth)acrylate, neopentyl glycol di(meth)acrylate, trimethylolpropane tri(meth)acrylate, polyethylene glycol di(meth)acrylate, polypropylene glycol di(meth)acrylate, diallylphthalate, divinylbenzene, allyl(meth)acrylate, or the like can be used.

The vinyl monomer containing a cross-linkable functional group is preferably used within a range from 0 to 1.5% by mass, more preferably within a range from 0 to 0.15% by mass, with respect to the total amount of the aforementioned vinyl monomer mixture, in view of adjusting the elution rate of the vinyl polymer (A) to be obtained in tetrahydrofuran within a range from 10 to 90% by mass.

Next, a method for producing the vinyl polymer (A) will be described.

Although the vinyl polymer (A) can be produced by polymerizing the aforementioned vinyl monomer mixture using a conventionally known method, it is preferable to adopt an emulsion polymerization process in view of obtaining the vinyl polymer (A) having an elution rate within the aforementioned specific range.

As the emulsion polymerization process, for example, a method in which water, a vinyl monomer mixture, a polymerization initiator, and, if necessary, a chain transfer agent, an emulsifier, a dispersion stabilizer, or the like are collectively supplied to a reaction vessel, and mixed and polymerized therein; a monomer dropping method in which a vinyl monomer mixture is added dropwise and polymerized in a reaction vessel; a preemulsion method in which a vinyl monomer mixture, an emulsifier or the like and water are mixed in advance and the resulting mixture is then added dropwise and polymerized in a reaction vessel; and the like can be employed.

Although the reaction temperature for the emulsion polymerization process differs depending on the types of vinyl monomers and polymerization initiator used, for example, a reaction temperature of about 30 to about 90° C. is preferable, and a reaction time of, for example, about 1 to about 10 hours is preferable.

As the polymerization initiators, for example, persulfate salts such as potassium persulfate, sodium persulfate and ammonium persulfate; organic peroxides such as benzoyl peroxide, cumene hydroperoxide and t-butyl hydroperoxide; hydrogen peroxide and the like are available. The polymerization process can be conducted by a radical polymerization using these peroxides alone; by a redox polymerization initiator system in which the peroxide, a metal salt of ascorbic acid or formaldehyde sulfoxylate, and a reducing agent such as sodium thiosulfate, sodium bisulfite and ferric chloride are used concomitantly; or by the use of an azo-based initiator such as 4,4′-azobis(4-cyanovaleric acid) and 2,2′-azobis(2-amidinopropane) dihydrochloride, and these initiators can be used either alone or as a mixture of 2 or more types thereof.

Examples of the emulsifiers which can be used for producing the vinyl polymer (A) include an anionic surface active agent, a nonionic surface active agent, a cationic surface active agent and an amphoteric surface active agent, and, among them, it is particularly preferable to use an anionic surface active agent.

Examples of the anionic surface active agent include a sulfuric acid ester of higher alcohols or a salt thereof, alkylbenzenesulfonic acid salt, polyoxyethylene alkyl phenyl sulfonic acid salt, polyoxyethylene alkyl diphenyl ether sulfonic acid salt, a sulfuric acid half ester salt of polyoxyethylene alkyl ether, alkyl diphenyl ether disulfonic acid salt, and succinic acid dialkylester sulfonic acid salt. As the nonionic surfactant, for example, polyoxyethylene alkyl ether, polyoxyethylene alkyl phenyl ether, polyoxyethylene diphenyl ether, polyoxyethylene-polyoxypropylene block copolymers, acetylenediol-based surface active agent or the like can be used.

In addition, as the cationic surface active agent, for example, an alkyl ammonium salt or the like can be used.

Further, as the amphoteric surface active agent, for example, alkyl (amide) betaine, alkyldimethylamine oxide or the like can be used.

As the emulsifier, in addition to the above-mentioned surface active agents, a fluorine-based surface active agent, a silicone-based surface active agent, or an emulsifier generally referred to as a “reactive emulsifier” having a polymerizable unsaturated group within the molecule can also be used.

As the reactive emulsifier, for example, “LATEMULE S-180” (manufactured by Kao Corporation), “ELEMINOL JS-2” and “ELEMINOL RS-30” (manufactured by

Sanyo Chemical Industries, Ltd.), and the like which have a sulfonate group and a salt thereof; “Aquaron HS-10”, “Aquaron HS-20” and “Aquaron KH-1025” (manufactured by Dai-ichi Kogyo Seiyaku Co., Ltd.), “ADEKA REASOAP SE-10” and “ADEKA REASOAP SE-20” (manufactured by ADEKA Corporation) and the like which have a sulfate group and a salt thereof; “New Frontier A-229E” (manufactured by Dai-ichi Kogyo Seiyaku Co., Ltd.) and the like which have a phosphate group; and “Aquaron RN-10”, “Aquaron RN-20”, “Aquaron RN-30”, and “Aquaron RN-50” (manufactured by Dai-ichi Kogyo Seiyaku Co., Ltd.) and the like which have a nonionic hydrophilic group can be used.

In addition, as the water-based medium used in the production of the vinyl polymer (A), the same as those described above as the water-based medium (B) can be used.

Further, as the chain transfer agent which can be used in the production of the vinyl polymer (A), lauryl mercaptan or the like can be used. It is preferable to use the chain transfer agent within a range from 0 to 0.15% by mass, more preferably within a range from 0 to 0.08% by mass, with respect to the total amount of the aforementioned vinyl monomer mixture from the viewpoint of adjusting the elution rate of the vinyl polymer (A) in tetrahydrofuran within a range from 10 to 90% by mass.

In addition, when producing the vinyl polymer (A), if necessary, a dispersion stabilizer such as polyvinyl alcohol may be used.

It is preferable that the vinyl polymer (A) obtained by the aforementioned method be contained within a range from 20 to 50% by mass, with respect to the total amount of the inkjet receiving agent for an oil based pigment ink according to the present invention.

Next, the water-based medium (B) used in the production of the inkjet receiving agent for an oil based pigment ink will be described.

The water-based medium (B) is used for dispersing the vinyl polymer (A), and either water alone may be used or a mixed solution of water and a water-soluble solvent may be used. As the water-soluble solvent, for example, alcohols such as methyl alcohol, ethyl alcohol, isopropyl alcohol, ethyl carbitol, ethyl cellosolve and butyl cellosolve and polar solvents such as N-methylpyrrolidone can be used.

In the inkjet receiving agent for an oil based pigment ink according to the present invention, if required, a known agent such as a cross-linking agent, a filler, a pigment, a pH adjusting agent, a coating film formation auxiliary agent, a leveling agent, a thickening agent, a water repellent agent and an antifoaming agent can be added and used, where appropriate, within a range so that the effects of the present invention are not impaired.

Among them, it is preferable to use the aforementioned cross-linking agent from the viewpoint of adjusting the crosslinking density of the ink receiving layer. As the cross-linking agent, for example, a polyfunctional epoxy compound, a polyfunctional oxazoline compound, a polyfunctional carbodiimide compound, a polyfunctional melamine compound, a polyfunctional polyamine compound, a polyfunctional polyethyleneimine compound, a polyfunctional (block) isocyanate compound, a polyfunctional hydrazine compound, a metal salt compound, or the like can be used.

Further, in addition to the additives mentioned above, it is also possible to use, by mixing, a water-soluble, or water-dispersible thermosetting resin such as a phenolic resin, a urea resin, a melamine resin, a polyester resin, a polyamide resin and a urethane resin.

Although the amount of the above additive used is not particularly limited as long as the effects of the present invention are not impaired, it is preferably within a range from 0.01 to 40% by mass with respect to the total solid content in the inkjet receiving agent.

Next, the inkjet recording medium for an oil based pigment ink according to the present invention will be described.

The inkjet recording medium for an oil based pigment ink according to the present invention includes a receiving layer constituted of the inkjet receiving agent for an oil based pigment ink formed either on one surface or both surfaces of a substrate made of various materials. The receiving layer may be laminated on top of the substrate, or the substrate may be impregnated with a portion of the receiving layer.

The inkjet recording medium for an oil based pigment ink according to the present invention is capable of developing highly excellent levels of color developing properties and water resistance even when an inkjet printing is conducted using a pigment ink, and thus can be used for advertisements in both indoors and outdoors such as billboards, transit advertising, and banners.

The inkjet recording medium for an oil based pigment ink according to the present invention can be produced by first coating the aforementioned inkjet receiving agent for an oil based pigment ink on either one surface or both surfaces of a substrate (or by impregnating the substrate with the inkjet receiving agent in those cases where the substrate is a fiber substrate or the like), and then volatilizing a water-based medium contained in the inkjet receiving agent.

As the substrate, for example, good quality paper, coated paper, and plastic sheets made of polyethylene terephthalate, polyvinylidene fluoride, polyvinylidene chloride, polyvinyl alcohol, polycarbonate, polyethylene, polypropylene, polyurethane or the like can be used.

In addition, as the substrate, for example, substrates made of synthetic fibers such as polyester fiber, polyamide fiber and aramid fiber, and natural fibers such as cotton and hemp can also be used. The fibers described above may be processed in advance.

As a method for coating the inkjet receiving agent on top of the substrate or impregnating the substrate with the inkjet receiving agent, conventionally known methods involving, for example, a gravure system, a coating system, a screening system, a roller system, a rotary system, a spray system, or the like can be employed.

In addition, although the method for volatilizing the water-based medium (B) contained in the receiving layer is not particularly limited, following the coating of the inkjet receiving agent for an oil based pigment ink according to the present invention on top of the substrate (or the impregnation of the agent to the substrate), for example, a drying method using a dryer is common. The drying temperature may be set to a temperature within a range so that the water-based medium can be volatilized without adversely affecting the substrate.

The amount of the inkjet receiving agent for an oil based pigment ink deposited on the substrate is preferably within a range from 10 to 60 g/m² with respect to the substrate area from the viewpoint of maintaining a considerably high level of color developing properties and also maintaining a favorable level of production efficiency, and particularly preferably within a range from 20 to 40 g/m² when taking ink absorption properties and production cost into consideration.

In addition, by increasing the amount of the inkjet receiving agent for an oil based pigment ink deposited on the substrate, it is possible to further improve the color developing properties of the inkjet recording medium for an oil based pigment ink. It should be noted that since the texture of the inkjet recording medium tends to harden to some extent as the amount of deposition increases, it is preferable to appropriately adjust the deposition amount depending on the intended use of the recording medium or the like.

In addition, when providing an ink receiving layer included in the inkjet recording medium of the present invention on top of the substrate, the film thickness thereof is preferably within a range from about 15 to about 50 μm.

A printing can be conducted using an oil based pigment ink on the inkjet recording medium for an oil based pigment ink according to the present invention obtained by the method described above.

As the oil based pigment ink which can be used for the above printing, those formed by dissolving or dispersing a pigment ink in a solvent composed of an organic solvent can be used.

As the organic solvent, for example, it is preferable to use alcohols, ethers, esters, ketones or the like which have a boiling point of 100 to 250° C. from the viewpoint of preventing the drying or clogging of an inkjet head, and those having a boiling point of 120 to 220° C. are more preferable.

As the alcohols, for example, ethylene glycol, triethylene glycol, tetraethylene glycol, propylene glycol, dipropylene glycol or the like can be used.

As the ethers, for example, ethylene glycol mono(methyl, ethyl, butyl, phenyl, benzyl or ethylhexyl) ether, ethylene glycol di(methyl, ethyl or butyl) ether, diethylene glycol mono(methyl, ethyl or butyl) ether, diethylene glycol di(methyl, ethyl or butyl) ether, tetraethylene glycol mono(methyl, ethyl or butyl) ether, tetraethylene glycol di(methyl, ethyl or butyl) ether, propylene glycol mono(methyl, ethyl or butyl) ether, dipropylene glycol mono(methyl or ethyl) ether, tripropylene glycol monomethyl ether, or the like can be used.

Examples of the esters include ethylene glycol mono(methyl, ethyl or butyl) ether acetate, ethylene glycol di(methyl, ethyl or butyl) ether acetate, diethylene glycol mono(methyl, ethyl or butyl) ether acetate, diethylene glycol di(methyl, ethyl or butyl) ether acetate, propylene glycol mono(methyl, ethyl or butyl) ether acetate, dipropylene glycol mono(methyl or ethyl) ether acetate, tripropylene glycol monomethyl ether acetate, 2-(methoxy, ethoxy or butoxy)ethyl acetate, 2-ethylhexyl acetate, dimethyl phthalate, diethyl phthalate and butyl lactate. Examples of the ketones include cyclohexanone.

Among them, it is particularly preferable to use an oil based pigment ink containing diethylene glycol diethyl ether, tetraethylene glycol monobutyl ether, tetraethylene glycol dimethyl ether, ethylene glycol monobutyl ether acetate or propylene glycol monomethyl ether acetate.

In addition, as the pigment, for example, organic pigments such as quinacridone-based pigments, anthraquinone-based pigments, perylene-based pigments, perinone-based pigments, diketopyrrolopyrrole-based pigments, isoindolinone-based pigments, condensed azo-based pigments, benzimidazolone-based pigments, monoazo-based pigments, insoluble azo-based pigments, naphthol-based pigments, flavanthrone-based pigments, anthrapyrimidine-based pigments, quinophthalone-based pigments, pyranthrone-based pigments, pyrazolone-based pigments, thioindigo-based pigments, ansanthrone-based pigments, dioxazine-based pigments, phthalocyanine-based pigments, and indanthrone-based pigments; metal complexes such as nickel dioxin yellow and copper azomethine yellow; metal oxides such as titanium oxide, iron oxide and zinc oxide; metal salts such as barium sulfate and calcium carbonate; inorganic pigments such as carbon black and mica; fine powders of metals, such as aluminum; and fine powders of mica or the like can be used. The pigment is preferably used within a range from 0.5 to 15% by mass, more preferably within a range from 1 to 10% by mass, with respect to the total amount of an oil based pigment ink.

As described above, a printed material obtained by carrying out an inkjet printing using an oil based pigment ink on a recording medium having an ink receiving layer that is formed using the inkjet receiving agent for an oil based pigment ink according to the present invention is one in which clear images are formed with a high level of color optical density and also having excellent water resistance, and thus it can be used for indoor or outdoor advertisements and transit advertising.

### EXAMPLES

The present invention will be described in detail below using a series of Examples.

### [Method for Preparing a Film Used for Measuring Glass Transition Temperature and Elution Rate]

An inkjet receiving agent was poured on top of a polypropylene film enclosed with a cardboard so that the resulting film thickness following drying was 150 μm, and was dried for 24 hours under the conditions of a temperature of 23° C. and a humidity of 65%. Following drying, the resultant was heated at 150° C. for 5 minutes, thereby preparing a film due to the separation from the polypropylene film. The obtained film was used for the measurements of glass transition temperature and elution rate.

### [Method for Measuring Glass Transition Temperature (Actually Measured Tg)]

10 mg of the film obtained by the aforementioned method was weighed and placed in an aluminum cylindrical cell having a diameter of 5 mm and a depth of 2 mm, and the measurements were made using a differential scanning calorimeter (DSC Q100) manufactured by TA Instruments Inc., in accordance with JIS K7121.

### [Method for Measuring Elution Rate]

The above-mentioned film was cut out into a square shape of 3 cm×3 cm, and the mass (X) thereof was measured. Subsequently, the film was immersed in 50 ml of the tetrahydrofuran which is adjusted to a temperature of 25° C. for 24 hours, and the film residues that did not dissolve in tetrahydrofuran (insoluble fraction) were then separated from tetrahydrofuran by filtration using a metal gauze having 300 meshes. The collected residues (insoluble fraction) were then dried at 108° C. for 1 hour, and the mass (Y) thereof was then measured.

Then, the elution rate was calculated using the aforementioned values for mass (X) and mass (Y), based on the formula: [{(X)−(Y)}/(X)]×100.

### [Method for Measuring Weight Average Molecular Weight]

As a sample to be used for the measurement of the weight average molecular weight of the vinyl polymer (A), 80 mg of the vinyl polymer (A) and 20 ml of tetrahydrofuran was mixed, and the mixture was stirred for 12 hours and then filtered using a 1 μm membrane filter, thereby obtaining a filtrate which was used as the sample. It should be noted that during the filtration using a membrane filter, with regard to the samples in which the presence of vinyl polymer insoluble in tetrahydrofuran was observed and the samples in which the aforementioned filtration process was difficult to perform even when a pressure was applied although the presence of vinyl polymer insoluble in tetrahydrofuran was not apparent, the measurement of the weight average molecular weight by gel permeation chromatography (GPC) to be described later was difficult was difficult to conduct. Therefore, the weight average molecular weight of the above samples was regarded as 1,000,000 or more.

The weight average molecular weight was measured by gel permeation chromatography (GPC). A high performance liquid chromatograph (HLC-8220 model) manufactured by Tosoh Corporation was used as a measuring instrument while the TSKgel GMHXL (×4) columns manufactured by Tosoh Corporation wereused as columns. Tetrahydrofuran was used as an eluant, and the measurements were made using a refractive index (RI) detector.

Example 1

### Preparation of Inkjet Receiving Agent (A-1) for Oil Based Pigment Ink and Production of Inkjet Recording Medium Using the Agent>

115 parts by mass of deionized water and 4 parts by mass of “LATEMULE 118B” (manufactured by Kao Corporation: containing an active ingredient of 25% by mass) were charged to a reaction vessel equipped with a stirrer, a reflux condenser, a nitrogen inlet tube, a thermometer, and a dropping funnel, and the temperature of the mixture was increased to 75° C. while blowing in nitrogen thereto.

While stirring, 0.1 parts by mass of potassium persulfate was added to the reaction vessel, followed by the addition of a portion (5 parts by mass) of a monomer preemulsion obtained by mixing a vinyl monomer mixture composed of 60.0 parts by mass of methyl methacrylate, 1.0 parts by mass of methacrylic acid serving as a carboxyl group containing vinyl monomer, 2.0 parts by mass of acrylamide serving as an amide group containing vinyl monomer and 37.0 parts by mass of butyl acrylate, with 4 parts by mass of “Aquaron KH-1025” (manufactured by Dai-ichi Kogyo Seiyaku Co., Ltd., containing 25% by mass of active ingredient) and 15 parts by mass of deionized water, and a polymerization was conducted for 60 minutes while maintaining the temperature inside the reaction vessel at 75° C.

Subsequently, while maintaining the temperature inside the reaction vessel at 75° C., the rest of the monomer preemulsion (114 parts by mass) and 30 parts by mass of an aqueous potassium persulfate solution (containing 1.0% by mass of an active ingredient) were dropwise added thereto over 180 minutes, using a separate dropping funnel. Following completion of dropwise addition, the resulting mixture was stirred for 60 minutes at the same temperature.

The temperature inside the reaction vessel was cooled to 40° C., and aqueous ammonia (containing 10% by mass of an active ingredient) was used so that the pH of the aqueous dispersion in the reaction vessel was 8.5.

Deionized water was then used so that the nonvolatile content reached 40.0% by mass, and the resultant was then filtered using a 200 mesh filter cloth, thereby obtaining an inkjet receiving agent (A-1) for an oil based pigment ink according to the present invention.

### (Production of Inkjet Recording Medium)

The inkjet receiving agent (A-1) for an oil based pigment ink was coated on a polyethylene terephthalate film (Cosmo Shine A4100 manufactured by Toyobo Co., Ltd., having a thickness of 50 μm) using a bar coater so that the film thickness of a dried film became 30 μm, and was then dried at 120° C. for 4 minutes using a hot air dryer, thereby obtaining an inkjet recording medium.

### Examples 2 to 9

### Preparation of Inkjet Receiving Agents (A-2) to (A-9) for Oil Based Pigment Ink and Production of Inkjet Recording Medium Using these Agents

The inkjet receiving agents (A-2) to (A-8) for oil based pigment ink were prepared by the same method as that described in Example 1 with the exception that the compositions of the acrylic monomer mixtures were changed to those indicated in Table 1 shown below. In addition, the inkjet receiving agent (A-9) for oil based pigment ink was obtained by the same method as that described in Example 1 with the exception that the composition of the acrylic monomer mixture was changed to that indicated in Table 1 shown below, and that a chain transfer agent was used in an amount indicated in Table 1 shown below.

### Comparative Examples 1 to 8

### Preparation of Inkjet Receiving Agents (A′-1) to (A′-8) for Oil Based Pigment Ink and Production of Inkjet Recording Medium Using these Agents

The inkjet receiving agents (A′-1), (A′-2), and (A′-4) to (A′-8) for oil based pigment ink for comparison were prepared by the same method as that described in Example 1 with the exception that the compositions of the acrylic monomer mixtures were changed to those indicated in Table 2 shown below. In addition, the inkjet receiving agent (A′-3) for oil based pigment ink was obtained by the same method as that described in Example 1 with the exception that the composition of the acrylic monomer mixture was changed to that indicated in Table 2 shown below, and that a chain transfer agent was used in an amount indicated in Table 1 shown below.

### [Method for Evaluating Color Optical Density]

100% solid images of each cyan, magenta, yellow and black colors were obtained by printing 100% solid images of each colors separately with oil based pigment inks on each of the aforementioned inkjet recording media using an inkjet printer (SP-300V; manufactured by Roland DG Corporation).

The color optical density was measured for each of the 100% solid images obtained above, using DensiEye 700E/P/L (manufactured by GretagMacbeth Corporation).

### [Method for Evaluating Printing Properties (Presence of Bleeding, Cracks or the Like in the Printed Images)]

400% solid images of each cyan, magenta, yellow and black colors were obtained by printing (overlaying) 100% solid images of each colors with oil based pigment inks on top of the respective inkjet recording media obtained by the aforementioned method using an inkjet printer (SP-300V; manufactured by Roland DG Corporation).

Evaluation of printing properties was made by visually observing the presence of bleeding, cracks, or creases in the surface of the aforementioned 400% solid images. More specifically, those in which no bleeding and the like was observed on the image surface at all were graded as “A”, those in which bleeding or cracks were observed in a region corresponding to about less than 10% of the entire image surface were graded as “B”, those in which bleeding or cracks were observed in a region corresponding to about 10% to less than 50% of the entire image surface were graded as “C”, and those in which bleeding or cracks were observed in a region corresponding to more than 50% of the entire image surface were graded as “D”, respectively.

### [Method for Evaluating Drying Properties]

The drying properties of oil based pigment inks were evaluated, based on the presence of ink deposition on paper, by first printing a 400% solid image as described above and then pressing a piece of ordinary paper against the surface of the image 3 minutes later. More specifically, those in which no ink deposition was observed in the portion of ordinary paper which brought into contact with the image surface were graded as “A”, those in which ink deposition was observed in a region corresponding to about less than 10% of the portion were graded as “B”, those in which ink deposition was observed in a region corresponding to about 10% to less than 50% of the portion were graded as “C”, and those in which ink deposition was observed in a region corresponding to more than 50% of the portion were graded as “D”, respectively.

### [Method for Evaluating Water Resistance]

The water resistance was evaluated by immersing a printed material to which a 400% solid image was printed as described above in water for 1 week, and then visually comparing the resultant with a 400% solid image which has not been immersed in water. More specifically, those in which no change in the image was observed before and after the immersion in terms of the presence of cracks or the like were graded as “A”, those in which cracks or the like was observed in the image following immersion in a region corresponding to about less than 10% of the entire image surface were graded as “B”, those in which cracks or the like was observed in the image following immersion in a region corresponding to about 10% to less than 50% of the entire image surface were graded as “C”, and those in which cracks or the like was observed in the image following immersion in a region corresponding to more than 50% of the entire image surface were evaluated as “D”, respectively.

TABLE 1

| | | Example | | | | | | | | |
|---|---|---|---|---|---|---|---|---|---|---|
| | | 1 | 2 | 3 | 4 | 5 | 6 | 7 | 8 | 9 |
| MMA | Parts | 60.0 | 67.0 | 50.0 | 37.0 | 60.0 | 60.0 | 60.5 | 59.8 | 59.9 |
| MAA | by | 1.0 | 1.0 | 1.0 | 1.0 | 2.0 | — | — | 1.0 | 1.0 |
| AM | mass | 2.0 | 2.0 | 2.0 | 2.0 | — | 4.0 | 0.5 | 2.0 | 2.0 |
| BA | | 37.0 | 30.0 | 47.0 | 40.0 | 38.0 | 36.0 | 39.0 | 37.0 | 37.0 |
| CHMA | | — | — | — | 20.0 | — | — | — | — | — |
| TBMA | | — | — | — | — | — | — | — | — | — |
| EMA | | — | — | — | — | — | — | — | — | — |
| A-TMPT | | — | — | — | | — | — | — | 0.2 | — |
| L-SH | | — | — | — | — | — | — | — | — | 0.1 |
| Tg (° C.) | | 32 | 43 | 15 | 24 | 36 | 37 | 29 | 37 | 37 |
| Elution rate (% by mass) | | 45 | 40 | 29 | 33 | 37 | 41 | 74 | 14 | 85 |
| Weight average | | 1.0 × | 1.0 × | 1.0 × | 1.0 × | 1.2 × | 1.0 × | 1.0 × | 1.0 × | 0.8 × |
| molecular weight | | 10⁶ or | 10⁶ or | 10⁶ or | 10⁶ or | 10⁶ | 10⁶ or | 10⁶ or | 10⁶ or | 10⁶ |
| | | more | more | more | more | | more | more | more | |
| Color optical | C | 2.73 | 2.60 | 2.70 | 2.70 | 2.74 | 2.65 | 2.63 | 2.65 | 2.62 |
| density | M | 1.88 | 1.75 | 1.80 | 1.78 | 1.80 | 1.88 | 1.79 | 1.71 | 1.70 |
| | Y | 1.64 | 1.63 | 1.59 | 1.62 | 1.60 | 1.62 | 1.64 | 1.60 | 1.63 |
| | K | 3.09 | 3.02 | 3.08 | 3.08 | 3.06 | 3.02 | 3.01 | 3.01 | 2.84 |

| | | | | | | | | | |
|---|---|---|---|---|---|---|---|---|---|
| Printing properties | A | B | A | A | A | A | B | B | B |
| Drying properties | A | A | A | A | B | B | B | B | B |
| Water resistance | A | A | B | B | B | A | A | A | B |

TABLE 2

| | | Comparative Example | | | | | | | |
|---|---|---|---|---|---|---|---|---|---|
| | | 1 | 2 | 3 | 4 | 5 | 6 | 7 | 8 |
| MMA | Parts | 15.0 | 85.0 | 60.0 | 60.0 | 60.0 | 60.0 | 52.0 | — |
| MAA | by | 2.0 | 2.0 | 2.0 | 2.0 | 0.1 | — | 10.0 | 1.0 |
| AM | mass | — | — | — | — | — | 0.1 | — | 2.0 |
| BA | | 58.0 | 13.0 | 37.8 | 36.0 | 39.9 | 39.9 | 38.0 | 37.0 |
| CHMA | | — | — | — | — | — | — | — | — |
| TBMA | | 25.0 | — | — | — | — | — | — | — |
| EMA | | — | — | — | — | — | — | — | 60.0 |
| A-TMPT | | — | — | — | 2.0 | — | — | — | — |
| L-SH | | — | — | 0.2 | — | — | — | — | — |
| Tg (° C.) | | 1 | 76 | 36 | 40 | 34 | 27 | 58 | 12 |
| Elution rate (% by mass) | | 32 | 50 | 94 | 5 | 94 | 97 | 95 | 60 |
| Weight average | | 1.0 × | 1.0 × | 0.41 × | 1.0 × | 0.67 × | 0.68 × | 0.65 × | 1.0 × |
| molecular weight | | 10⁶ or | 10⁶ or | 10⁶ | 10⁶ or | 10⁶ | 10⁶ | 10⁶ | 10⁶ or |
| | | more | more | | more | | | | more |
| Color optical | C | 2.70 | 2.73 | 2.61 | 1.94 | 2.67 | 2.63 | 2.65 | 2.66 |
| density | M | 1.80 | 1.80 | 1.69 | 1.41 | 1.74 | 1.71 | 1.79 | 1.79 |
| | Y | 1.59 | 1.62 | 1.62 | 1.62 | 1.52 | 1.62 | 1.54 | 1.56 |
| | K | 3.08 | 3.02 | 2.82 | 1.90 | 2.87 | 2.99 | 2.87 | 2.98 |

| | | | | | | | | |
|---|---|---|---|---|---|---|---|---|
| Printing properties | D | B | D | D | D | D | D | B |
| Drying properties | D | B | B | B | B | B | B | C |
| Water resistance | D | D | B | B | C | C | C | D |

### ABBREVIATIONS USED IN TABLES 1 and 2

MMA: Methyl methacrylate
MAA: Methacrylic acid
AM: Acrylamide
BA: Butyl acrylate
CHMA: Cyclohexyl methacrylate
TBMA: t-butyl methacrylate
EMA: Ethyl methacrylate
A-TMPT: Trimethylolpropane triacrylate (vinyl monomer containing cross-linkable functional group)
L-SH: Lauryl mercaptan (chain transfer agent)
Tg: Glass transition temperature

1. An inkjet receiving agent for an oil based pigment ink comprising:
a vinyl polymer (A) dispersed in a water-based medium (B),
the vinyl polymer (A) having a glass transition temperature of 10 to 70° C. and being obtained by polymerizing a vinyl monomer mixture containing 30 to 70% by mass of methyl methacrylate (a1) and a total of 0.2 to 5.0% by mass of at least one monomer selected from the group consisting of a carboxyl group containing vinyl monomer (a2) and an amide group containing vinyl monomer (a3),
wherein an elution rate is 10 to 90% by mass when the vinyl polymer (A) is immersed in tetrahydrofuran of 25° C. for 24 hours.

2. The inkjet receiving agent for an oil based pigment ink according to claim 1,
wherein the elution rate indicates a ratio of a mass of the vinyl polymer (A), which is eluted from the film that is formed using the vinyl polymer (A) into tetrahydrofuran when the film is immersed in the tetrahydrofuran of 25° C. for 24 hours, to a mass of the film.

3. The inkjet receiving agent for an oil based pigment ink according to claim 1,
wherein the vinyl polymer (A) is obtained by polymerizing a vinyl monomer mixture containing 30 to 70% by mass of methyl methacrylate (a1), a total of 0.2 to 5.0% by mass of at least one monomer selected from the group consisting of a carboxyl group containing vinyl monomer (a2) and an amide group containing vinyl monomer (a3), and 10 to 50% by mass of an alkyl(meth)acrylate ester (a4) having an alkyl group of 2 to 8 carbon atoms.

4. The inkjet receiving agent for an oil based pigment ink according to claim 1,
wherein the vinyl polymer (A) is obtained by polymerizing a vinyl monomer mixture containing 30 to 70% by mass of methyl methacrylate (a1), a total of 0.2 to 5.0% by mass of at least one monomer selected from the group consisting of a carboxyl group containing vinyl monomer (a2) and an amide group containing vinyl monomer (a3), 10 to 50% by mass of an alkyl(meth)acrylate ester (a4) having an alkyl group of 2 to 8 carbon atoms, and 0 to 1.5% by mass of a vinyl monomer containing a cross-linkable functional group.

5. The inkjet receiving agent for an oil based pigment ink according to claim 1,
wherein the vinyl polymer (A) is obtained by an emulsion polymerization process of the vinyl monomer mixture in the presence of a water-based medium and 0 to 0.15% by mass of a chain transfer agent with respect to the total amount of the vinyl monomer mixture.

6. An inkjet recording medium for an oil based pigment ink comprising an inkjet receiving layer formed using the inkjet receiving agent for an oil based pigment ink according to claim 1.

7. A printed material in which printing using an oil based pigment ink is conducted on an inkjet receiving layer of the inkjet recording medium for an oil based pigment ink according to claim 6.

8. The inkjet receiving agent for an oil based pigment ink according to claim 4,
wherein the vinyl polymer (A) is obtained by an emulsion polymerization process of the vinyl monomer mixture in the presence of a water-based medium and 0 to 0.15% by mass of a chain transfer agent with respect to the total amount of the vinyl monomer mixture.

9. An inkjet recording medium for an oil based pigment ink comprising an inkjet receiving layer formed using the inkjet receiving agent for an oil based pigment ink according to claim 2.

10. An inkjet recording medium for an oil based pigment ink comprising an inkjet receiving layer formed using the inkjet receiving agent for an oil based pigment ink according to claim 3.

11. An inkjet recording medium for an oil based pigment ink comprising an inkjet receiving layer formed using the inkjet receiving agent for an oil based pigment ink according to claim 4.

12. An inkjet recording medium for an oil based pigment ink comprising an inkjet receiving layer formed using the inkjet receiving agent for an oil based pigment ink according to claim 5.

13. An inkjet recording medium for an oil based pigment ink comprising an inkjet receiving layer formed using the inkjet receiving agent for an oil based pigment ink according to claim 8.

14. A printed material in which printing using an oil based pigment ink is conducted on an inkjet receiving layer of the inkjet recording medium for an oil based pigment ink according to claim 9.

15. A printed material in which printing using an oil based pigment ink is conducted on an inkjet receiving layer of the inkjet recording medium for an oil based pigment ink according to claim 10.

16. A printed material in which printing using an oil based pigment ink is conducted on an inkjet receiving layer of the inkjet recording medium for an oil based pigment ink according to claim 11.

17. A printed material in which printing using an oil based pigment ink is conducted on an inkjet receiving layer of the inkjet recording medium for an oil based pigment ink according to claim 12.

18. A printed material in which printing using an oil based pigment ink is conducted on an inkjet receiving layer of the inkjet recording medium for an oil based pigment ink according to claim 13.
